(19) United States
(12) Patent Application Publication
(10) Pub. No.: US 2022/0369717 A1
(43) Pub. Date: Nov. 24, 2022

(54) AEROSOL-GENERATING DEVICE FOR INDUCTIVE HEATING OF AN AEROSOL-FORMING SUBSTRATE

(71) Applicant: Philip Morris Products S.A., Neuchatel (CH)

(72) Inventors: Oleg MIRONOV, Cudrefin (CH); Jerome Christian COURBAT, Cortaillod (CH); Enrico STURA, Palezieux-Village (CH)

(73) Assignee: Philip Morris Products S.A., Neuchatel (CH)

(21) Appl. No.: 17/772,388

(22) PCT Filed: Oct. 29, 2020
(86) PCT No.: PCT/EP2020/080341

§ 371 Date: Apr. 27, 2022

(30) Foreign Application Priority Data
Oct. 31, 2019 (EP) 19206547.2

(51) Int. Cl. A24F 40/465; A24F 40/20; A24D 1/20; H05B 6/36; H05B 6/44; H05B 6/10

(52) U.S. Cl. CPC A24F 40/465; A24F 40/20; A24D 1/20; H05B 6/365; H05B 6/44; H05B 6/105

(57) ABSTRACT

An aerosol-generating device for generating an aerosol by inductive heating of an aerosol-forming substrate is provided, the device including: a device housing including a cavity configured to removably receive the substrate to be heated; an inductive heating arrangement including at least one induction coil configured to generate an alternating magnetic field within the cavity, the coil being arranged around at least a portion of the cavity; and a flux concentrator arranged around at least a portion of the induction coil and configured to distort the alternating magnetic field of the at least one inductive heating arrangement towards the cavity, the flux concentrator including or being made of a flux concentrator foil, and the flux concentrator foil including at least one of a permalloy or a nano-crystalline soft magnetic alloy. An aerosol-generating system including the aerosol-generating device and an aerosol-generating article is also provided.

The present invention relates to an aerosol-generating device for generating an aerosol by inductively heating an aerosol-forming substrate. The invention further relates to an aerosol-generating system comprising such a device and an aerosol-generating article, wherein the article comprises the aerosol-forming substrate to be heated.

Aerosol-generating systems based on inductively heating an aerosol-forming substrate that is capable to form an inhalable aerosol are generally known from prior art. Such systems may comprise an aerosol-generating device having a cavity for receiving the substrate to be heated. The substrate may be integral part of an aerosol-generating article that is configured for use with the device. For heating the substrate, the device may comprise an inductive heating arrangement that includes an induction coil for generating an alternating magnetic field within the cavity. The field is used to induce at least one of heat generating eddy currents or hysteresis losses in a susceptor which—in use of the system—is arranged in thermal proximity or direct physical contact with the substrate in order to be heated. In general, the susceptor may be either integral part of the device or integral part of the article.

However, the magnetic field may not only inductively heat the susceptor, but also interfere with other susceptive parts of the aerosol-generating device or susceptive external items in close proximity to the device. In order to reduce such undesired interference, the aerosol-generating device may be provided with a flux concentrator arranged around the inductive heating arrangement which acts to substantially confine the magnetic field generated by the heating arrangement within the volume enclosed by the flux concentrator. However, it has been observed that the confining effect is often reduced or even lost when the device has suffered from excessive force impacts or shocks, for example, after the device has accidentally fallen down. In addition, many flux concentrators are rather bulky and thus may significantly increase the overall mass and size of the aerosol-generating device.

Therefore, it would be desirable to have an aerosol-generating device and system for inductively heating an aerosol-forming substrate with the advantages of prior art solutions but without their limitations. In particular, it would be desirable to have an aerosol-generating device and system comprising a flux concentrator which provides enhanced robustness and a compact design.

According to the invention there is provided an aerosol-generating device for generating an aerosol by inductively heating an aerosol-forming substrate. The device comprises a device housing comprising a cavity configured for removably receiving the aerosol-forming substrate to be heated. The device further comprises an inductive heating arrangement comprising at least one induction coil for generating an alternating magnetic field within the cavity, wherein the at least one induction coil is arranged around at least a portion of the receiving cavity. The device also comprises a flux concentrator arranged around at least a portion of the induction coil and configured to distort the alternating magnetic field of the inductive heating arrangement towards the cavity during use of the device. The flux concentrator comprises, in particular is made of a flux concentrator foil.

According to the invention, it has been recognized that a flux concentrator which comprises, in particular is made of a flux concentrator foil, is more flexible than other flux concentrator configurations, for example ferritic solid bodies. Due to this, flux concentrator foils provide good shock absorption properties and, thus, can withstand higher excessive force impacts or shocks without breakage. For example, as compared to a susceptors made from sintered ferrite powder, a flexible flux concentrator foil offers a largely improved resistance to shock loading, such as resulting from accidental drop. In addition, flux concentrator foils allow for a more compact design of the aerosol-generating device due to their small dimensions. In particular, as compared to a sintered ferrite flux concentrators, flux concentrator foils can be made significantly thinner. Furthermore, in contrast to solid body flux concentrators, flux concentrator foils also allow for compensating manufacturing tolerances as well as for fine tuning the inductance. In particular, the flux concentrator foil may advantageously help to enhance the impedance stability of the inductive coil with temperature. In general, the impedance of the induction coil is affected by the presence of the flux concentrator. When using a flux concentrator foil, the conductance of the induction heating system may change less with temperature due to the small volume of the foil, in particular in comparison to large volume solid body flux concentrators. As a consequence of this, the impedance may also change less with temperature. Apart from that, flux concentrator foils are easy to manufacture.

As used herein, the term “concentrate the magnetic field” means that the flux concentrator is able to distort the magnetic field so that the density of the magnetic field is increased within the cavity.

By distorting the magnetic field towards the cavity, the flux concentrator reduces the extent to which the magnetic field propagates beyond the induction coil. That is, the flux concentrator acts as a magnetic shield. This may reduce undesired heating of adjacent susceptive parts of the device, for example a metallic outer housing, or undesired heating of adjacent susceptive items external to the device. By reducing undesired heating losses, the efficiency of the aerosol-generating device may be further improved.

Furthermore, by distorting the magnetic field towards the cavity, the flux concentrator advantageously can concentrate or focus the magnetic field within the cavity. This may increase the level of heat generated in the susceptor for a given level of power passing through the induction coil in comparison to induction coils having no flux concentrator. Thus, the efficiency of the aerosol-generating device may be improved.

As used herein, the term “foil” refers to a thin sheet material having a thickness much smaller than the dimension in any direction perpendicular to the direction of the thickness. As used herein, the term “thickness” refers to the dimension of the foil perpendicular to the major surfaces of the foil. In particular, the term “foil” may refer to a sheet material that is flexible and preferably bends under its own weight. More particularly, the term “foil” may refer to a sheet material that bends under its own weight by at least 5 degrees, in particular at least 20 degrees, more particularly at least 30 degrees per 2 centimeter length of a one side freely overhanging sample of the foil. The term “foil” may refer to a sheet material that bends under its own weight with a radius of curvature of at most 5 centimeter, in particular at most 2 centimeter, more particularly at most 1.5 centimeter,

Preferably, the flux concentrator foil has a thickness in a range between 0.02 mm (millimeters) and 0.25 mm (millimeters), in particular between 0.05 mm (millimeters) and 0.2 mm (millimeters), preferably between 0.1 mm (millimeters) and 0.15 mm (millimeters) or between 0.04 mm (millimeters) and 0.08 mm (millimeters) or between 0.03 mm (millimeters) and 0.07 mm (millimeters). Such values of the thickness allow for a particularly compact design of the aerosol-generating device. Yet, these values are still large enough to sufficiently distort the alternating magnetic field of the inductive heating arrangement towards the cavity during use of the device.

The thickness of the flux concentrator may be substantially constant along any direction perpendicular to the thickness of the flux concentrator. In other examples, the thickness of the flux concentrator may vary along one or more directions perpendicular to the thickness of the flux concentrator. For example, the thickness of the flux concentrator may taper, or decrease, from one end to another end, or from a central portion of the flux concentrator towards both ends. The thickness of the flux concentrator may be substantially constant around its circumference. In other examples, the thickness of the flux concentrator may vary around its circumference.

In general, the flux concentrator may have any shape, yet preferably a shape matching the shape of the at least one induction which the flux concentrator is arranged around at least partially.

For example, the flux concentrator may have a substantially cylindrical shape, in particular a sleeve shape or a tubular shape. That is, the flux concentrator may be a tubular flux concentrator or a flux concentrator sleeve or a cylindrical flux concentrator. Such shapes are particularly suitable in case the at least one induction coil is a helical induction coil having a substantially cylindrical shape. In such configurations, the flux concentrator completely circumscribes the at least one induction coil along at least a part of the axial length extension of the coil. A tubular shape or sleeve shape proves particularly advantageous with regard to a cylindrical shape of the cavity as well as with regard to a cylindrical and/or helical configuration of the induction coil. As to this shapes, the flux concentrator may have any suitable cross-section. For example, the flux concentrator may have a square, oval, rectangular, triangular, pentagonal, hexagonal, or similar cross-sectional shape. Preferably, the flux concentrator has a circular cross-section. For example, the flux concentrator may have a circular, cylindrical shape.

It is also possible that the flux concentrator only extends around a part of the circumference of the at least one induction coil.

In any of these configurations, the flux concentrator is preferably arranged coaxially with a center line of the at least one induction coil. Even more preferably, the flux concentrator and the at least one induction coil are coaxially with a center line of the cavity.

In general, the inductive heating arrangement may comprise a single induction coil or a plurality of induction coils, in particular two induction coils. In case of single induction coil, the flux concentrator is arranged around at least a portion of the single induction coil, preferably entirely around the induction coil. In case of a plurality of induction coils, the flux concentrator may be arranged around at least a portion of one of the induction coils, preferably around at least a portion of each one of the inductions coils, even more preferably entirely around each induction coil.

The flux concentrator foil may be wound up, in particular with ends overlapping each other or abutting against each other, such as to form a tubular flux concentrator or a flux concentrator sleeve. The ends overlapping each other or abutting each other may be attached to each other. Likewise, the ends overlapping each other or abutting against each other may loosely overlap each other or may loosely abut against each other.

In particular, the flux concentrator foil may be wound up in a single winding such as to form a tubular flux concentrator or a flux concentrator sleeve comprising a single winding of a flux concentrator foil. Alternatively, the flux concentrator foil may be wound up in multiple turns/windings such as to form a tubular flux concentrator or a flux concentrator sleeve comprising multiple, in particular spiral windings of the flux concentrator foil.

The flux concentrator foil may also be wound up helically in an axially direction with respect to winding axis such as to form a tubular flux concentrator or a flux concentrator sleeve comprising one or more helical windings of the flux concentrator foil overlapping each other.

Of course, it is also possible that the flux concentrator foil is wound up in separate concentric windings on top of each other. That is, the flux concentrator may comprise a plurality of flux concentrator foils wound up in separate concentric single (turn) windings on top of each other. Likewise, it is also possible that the flux concentrator foil is wound up in separate multiple spiral or multiple windings on top of each other. That is, the flux concentrator may comprise a plurality of flux concentrator foils wound up in separate concentric multiple spiral or helical (turn) windings on top of each other.

Furthermore, it also possible that the flux concentrator comprises a plurality of flux concentrator foils arranged side by side next to each other, wherein each flux concentrator foil is wound up in a single winding or in multiple spiral windings overlapping each other or in separate concentric windings on top of each other.

A configuration comprising multiple, in particular multiple spiral or multiple helical windings or multiple separate concentric windings on top of each other of a flux concentrator foils may be advantageously used to generate a multi-layer flux concentrator foil or multi-layer flux concentrator, wherein each winding corresponds to one layer. For example, the flux concentrator may comprise two, or three or four or five or six or more than six multiple spiral or multiple helical windings or multiple separate concentric windings. Accordingly, such a multi-layer flux concentrator foil or multi-layer flux concentrator may have a thickness which substantially corresponds to the thickness of single layer or foil times the number of windings or layers. For example, where the foil has a thickness in a range between 0.02 mm (millimeters) and 0.25 mm (millimeters), in particular between 0.05 mm (millimeters) and 0.2 mm (millimeters), preferably between 0.1 mm (millimeters) and 0.15 mm (millimeters), a multi-layer flux concentrator foil or a multi-layer flux concentrator comprising six layers may have thickness in a range between 0.12 mm (millimeters) and 1.5 mm (millimeters), in particular between 0.3 mm (millimeters) and 1.2 mm (millimeters), preferably between 0.6 mm (millimeters) and 0.9 mm (millimeters).

In case the flux concentrator foil is wound up, in particular in a single winding, such as to form a tubular flux concentrator or a flux concentrator sleeve, the concentrator foil may be attached to an inner surface of the device housing in a force-fitting manner due a partial release of an elastic restoring force of the wound-up flux concentrator foil. That is, the elastic restoring force presses the concentrator foil radially outwards against the inner surface of the device housing. In this configuration, the ends of the wound up foil preferably loosely overlap each other or loosely abut against each other. Advantageously, this configuration allows for a simple mounting of the flux concentrator, in particular without any additional fixing means.

It is also possible that the flux concentrator results from extruding a flux concentrator foil directly into the final shape of the flux concentrator. In particular, the flux concentrator may comprise or may be an extruded flux concentrator foil, for example, an extruded tubular flux concentrator foil or an extruded flux concentrator foil sleeve or an extruded cylindrical flux concentrator foil. The extruded tubular flux concentrator foil or the extruded flux concentrator foil sleeve or the extruded cylindrical flux concentrator foil may have a wall thickness in a range between 0.05 mm (millimeters) and 0.25 mm (millimeters), preferably between 0.1 mm (millimeters) and 0.15 mm (millimeters). The wall thickness may also be in a range between 0.12 mm (millimeters) and 1.5 mm (millimeters), in particular between 0.3 mm (millimeters) and 1.2 mm (millimeters), preferably between 0.6 mm (millimeters) and 0.9 mm (millimeters).

As used herein, the term “flux concentrator” refers to a component having a high relative magnetic permeability which acts to concentrate and guide the electromagnetic field or electromagnetic field lines generated by an induction coil.

As used herein, the term “high relative magnetic permeability” refers to a relative magnetic permeability of at least 100, in particular of at least 1000, preferably of at least 10000, even more preferably of at least 50000, most preferably of at least 80000. These example values refer to the maximum values of relative magnetic permeability for frequencies up to 50 kHz and a temperature of 25 degrees Celsius.

As used herein and within the art, the term “relative magnetic permeability” refers to the ratio of the magnetic permeability of a material, or of a medium, such as the flux concentrator, to the magnetic permeability of free space μ_0, where μ_0 is 4π·10⁻⁷ N·A⁻² (4·Pi·10E−07 Newton per square Ampere).

Accordingly, the flux concentrator foil preferably comprises, in particular is made of a material or materials having a relative magnetic permeability of at least of at least 100, in particular of at least 1000, preferably of at least 10000, even more preferably of at least 50000, most preferably of at least 80000. These values preferably refer to maximum values of relative magnetic permeability at frequencies up to 50 kHz and a temperature of 25 degrees Celsius.

The flux concentrator foil may comprise or may be made from any suitable material or combination of materials. Preferably, the flux concentrator foil comprises a ferrimagnetic or ferromagnetic material, for example a ferrite material, such as ferrite particles or a ferrite powder held in a matrix, or any other suitable material including ferromagnetic material such as iron, ferromagnetic steel, iron-silicon or ferromagnetic stainless steel. Likewise, the flux concentrator foil may comprise a ferrimagnetic or ferromagnetic material, such as ferrimagnetic or ferromagnetic particles or a ferrimagnetic or ferromagnetic powder held in a matrix. The matrix may comprise a binder, for example a polymer, such as a silicone. Accordingly, the matrix may be a polymer matrix, such as a silicone matrix.

The ferromagnetic material may comprise at least one metal selected from iron, nickel and cobalt and combinations thereof, and may contain other elements, such as chromium, copper, molybdenum, manganese, aluminum, titanium, vanadium, tungsten, tantalum, silicon. The ferromagnetic material may comprise from about 78 weight percent to about 82 weight percent nickel, between 0 and 7 weight percent molybdenum and the reminder iron.

The flux concentrator foil may comprise or be made of a permalloy. Permalloys are nickel-iron magnetic alloys, which typically contain additional elements such as molybdenum, copper and/or chromium.

The flux concentrator foil may comprise or be made of a mu-metal. A mu-metal is a nickel-iron soft ferromagnetic alloy with very high magnetic permeability, in particular of about 80000 to 100000. For example, the mu-metal may comprise approximately 77 weight percent nickel, 16 weight percent iron, 5 weight percent copper, and 2 weight percent chromium or molybdenum. Likewise, the mu-metal may comprise 80 weight percent nickel, 5 weight percent molybdenum, small amounts of various other elements, such as silicon, and the remaining 12 to 15 weight percent iron.

The flux concentrator foil may comprise or be made of an alloy available under the trademark Nanoperm® from MAGNETEC GmbH, Germany. Nanoperm® alloys are iron-based nano-crystalline soft magnetic alloys comprising from about 83 weight percent to about 89 weight percent iron. As used herein, the term “nano-crystalline” refers to a material having a grain size of about 5 nanometers to 50 nanometers.

The flux concentrator foil may comprise or be made of an alloy available under the trademark Vitrovac® or Vitroperm® from VACUUMSCHMELZE GmbH & Co. KG, Germany. Vitrovac® alloys are amorphous (metallic glasses), whereas Vitroperm® alloys are nano-crystalline soft magnetic alloys. For example, flux concentrator foil may comprise or be made of Vitroperm 220, Vitroperm 250, Vitroperm 270, Vitroperm 400, Vitroperm 500 or Vitroperm 800.

The flux concentrator foil may comprise or be made of a brazing foil available under the trademark Metglas® from Metglas®, Inc. USA or from Hitachi Metals Europe GmbH, Germany. Metglas® brazing foils are amorphous nickel based brazing foils.

In general, the flux concentrator foil may be either a single-layer flux concentrator foil or a multi-layer flux concentrator foil.

For example, the multi-layer flux concentrator foil may comprise a substrate layer film and at least one layer of a ferromagnetic material disposed upon the substrate layer.

According to another example, the multi-layer flux concentrator foil may comprise a multilayer stack comprising one or more pairs of layers, each pair comprising a spacing layer and a layer of a ferromagnetic material disposed upon the spacing layer.

According to another example, the multi-layer flux concentrator foil may comprise a substrate layer and a multilayer stack disposed upon the substrate layer, wherein the multilayer stack comprises one or more pairs of layers, each pair comprising a spacing layer and a layer of a ferromagnetic material disposed upon the spacing layer.

According to another example, the multi-layer flux concentrator foil may comprise a layer of a first ferromagnetic material and a multilayer stack disposed upon the layer of the first ferromagnetic material, wherein the multilayer stack comprises one or more pairs of layers, each pair comprising a spacing layer and a layer of a second ferromagnetic material disposed upon the spacing layer.

Vice versa, the multi-layer flux concentrator foil may comprise a multilayer stack and a layer of a first ferromagnetic material disposed upon the multilayer stack, wherein the multilayer stack comprises one or more pairs of layers, each pair comprising a spacing layer and a layer of a second ferromagnetic material disposed upon the spacing layer.

According to another example, the multi-layer flux concentrator foil may comprise a substrate layer, a layer of a first ferromagnetic material disposed upon the substrate layer and a multilayer stack disposed upon the layer of the first ferromagnetic material, wherein the multilayer stack comprises one or more pairs of layers, each pair comprising a spacing layer and a layer of a second ferromagnetic material disposed upon the spacing layer.

Vice versa, the multi-layer flux concentrator foil may comprise a substrate layer and a multilayer stack disposed upon the substrate layer and a layer of a first ferromagnetic material disposed upon the multilayer stack, wherein the multilayer stack comprises one or more pairs of layers, each pair comprising a spacing layer and a layer of a second ferromagnetic material disposed upon the spacing layer.

The one or more layers comprising a (first or second) ferromagnetic layer may comprise at least one metal selected from iron, nickel, copper, molybdenum, manganese, silicon, and combinations thereof. The ferromagnetic material may comprise from about 88 weight percent to about 82 weight percent nickel and from about 18 weight percent to about 20 weight percent iron. In particular, one or more layers comprising a (first or second) ferromagnetic layer may comprise or may be made of a foil. Preferably, the foil comprises or is made of one of a permalloy, a Nanoperm® alloy, a Vitroperm® alloy, such as Vitroperm 800, or a Metglas® brazing foil.

The first and the second ferromagnetic material may be the same or may be different from each other.

The substrate layer may comprise a polymeric film. The polymeric film may be selected from polyesters, polyimides, polyolefms, or combinations thereof. The substrate layer may comprise a release liner.

The spacing layer or one or more of the spacing layers may be a dielectric layer or a non-electrically conductive material to suppress the eddy current effect. The spacing layer or one or more of the spacing layers may be made of a ferromagnetic material with relatively lower magnetic permeability. The spacing layer or one or more of the spacing layers may comprise an acrylic polymer.

In addition, the multi-layer flux concentrator foil, in particular any one of the aforementioned multi-layer flux concentrators foils, may comprise a protective layer. The protective layer preferably forms at least one of two outer most layers (edge layers) of the multi-layer flux concentrator foil. The protective layer may comprise or may be made of polymers or ceramics.

Furthermore, the multi-layer flux concentrator foil, in particular any one of the aforementioned multi-layer flux concentrators foils, may comprise an adhesive layer such as an adhesive tape. The adhesive layer preferably forms at least one of two outer most layers of the multi-layer flux concentrator foil. In particular, the substrate layer according to any one of the aforementioned multi-layer flux concentrators foils may be an adhesive layer.

Preferably, one of the outer most layers of the multi-layer flux concentrator foil is protective layer and the respective other one of the outer most layers of the multi-layer flux concentrator foil is an adhesive layer.

The aerosol-generating device may comprise a radial gap between the at least one induction coil and the flux concentrator, which flux concentrator at least partially surrounds the induction coil. Accordingly, the gap also at least partially surrounds the induction coil. The gap may be an air gap or a gap filled with a filler material, for example, a polyimide, such as poly(4,4′-oxydiphenylene-pyromellitimide), also known as Kapton®, or any other suitable dielectric materials. For example, the induction coil may be wrapped by one or more layers of Kapton tape such as to fill the radial gap between the at least one induction coil and the flux concentrator. One layer of Kapton tape may have a thickness in a range between 40 micrometers and 80 micrometers.

The gap may have a radial extension in a range between 40 micrometers and 400 micrometers, in particular between 100 micrometers and 240 micrometers, for example 220 micrometers. Advantageously, the gap may help to reduce losses in the induction coil and to increase losses in the susceptor to be heated, that is, to increase the heating efficiency of the aerosol-generating device. The inductive heating arrangement may comprise at least one susceptor element which is part of the device. Alternatively, the at least one susceptor element may be integral part of an aerosol-generating article which comprises the aerosol-forming substrate to be heated. As part of the device, the at least one susceptor element is arranged or arrangeable at least partially within the cavity such as to be in thermal proximity to or thermal contact, preferably physical contact with the aerosol-forming substrate during use.

As used herein, the term “susceptor element” refers to an element that is capable to convert electromagnetic energy into heat when subjected to an alternating electromagnetic field. This may be the result of hysteresis losses and/or eddy currents induced in the susceptor, depending on the electrical and magnetic properties of the susceptor material. Hysteresis losses occur in ferromagnetic or ferrimagnetic susceptors due to magnetic domains within the material being switched under the influence of an alternating electromagnetic field. Eddy currents may be induced if the susceptor is electrically conductive. In case of an electrically conductive ferromagnetic or ferrimagnetic susceptor, heat can be generated due to both, eddy currents and hysteresis losses.

Accordingly, the susceptor element may be formed from any material that can be inductively heated to a temperature sufficient to generate an aerosol from the aerosol-forming substrate. Preferred susceptor elements comprise a metal or carbon. A preferred susceptor element may comprise a ferromagnetic material, for example ferritic iron, or a ferromagnetic steel or stainless steel. A suitable susceptor element may be, or comprise, aluminum. Preferred susceptor elements may be formed from 400 series stainless steels, for example grade 410, or grade 420, or grade 430 stainless steel.

The susceptor element may comprise a variety of geometrical configurations. The susceptor element may comprise or may be a susceptor pin, a susceptor rod, a susceptor blade, a susceptor strip or a susceptor plate. Where the susceptor element is part of the aerosol-generating device, the susceptor pin, susceptor pin, the susceptor rod, the susceptor blade, the susceptor strip or the susceptor plate may be project into the cavity of the device, preferably towards an opening of the cavity for inserting an aerosol-generating article into the cavity.

The susceptor element may comprise or may be a filament susceptor, a mesh susceptor, a wick susceptor.

Likewise, the susceptor element may comprise or may be susceptor sleeve, a susceptor cup, a cylindrical susceptor or a tubular susceptor. Preferably, the inner void of the susceptor sleeve, the susceptor cup, the cylindrical susceptor or the tubular susceptor is configured to removably receive at least a portion of the aerosol-generating article.

The aforementioned susceptor elements may have any cross-sectional shape, for example, circular, oval, square, rectangular, triangular or any other suitable shape.

As used herein, the term “aerosol-generating device” generally refers to an electrically operated device that is capable of interacting with at least one aerosol-forming substrate, in particular with an aerosol-forming substrate provided within an aerosol-generating article, such as to generate an aerosol by heating the substrate. Preferably, the aerosol-generating device is a puffing device for generating an aerosol that is directly inhalable by a user thorough the user's mouth. In particular, the aerosol-generating device is a hand-held aerosol-generating device.

In addition to the induction coil, the inductive heating arrangement may comprise an alternating current (AC) generator. The AC generator may be powered by a power supply of the aerosol-generating device. The AC generator is operatively coupled to the at least one induction coil. In particular, the at least one induction coil may be integral part of the AC generator. The AC generator is configured to generate a high frequency oscillating current to be passed through the induction coil for generating an alternating electromagnetic field. The AC current may be supplied to the induction coil continuously following activation of the system or may be supplied intermittently, such as on a puff by puff basis.

Preferably, the inductive heating arrangement comprises a DC/AC converter connected to the DC power supply including an LC network, wherein the LC network comprises a series connection of a capacitor and the induction coil.

The inductive heating arrangement preferably is configured to generate a high-frequency electromagnetic field. As referred to herein, the high-frequency electromagnetic field may be in the range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz).

The aerosol-generating device may further comprise a controller configured to control operation of the device. In particular, the controller may be configured to control operation of the inductive heating arrangement, preferably in a closed-loop configuration, for controlling heating of the aerosol-forming substrate to a pre-determined operating temperature. The operating temperature used for heating the aerosol-forming substrate may be at least 180 degree Celsius, in particular at least 300 degree Celsius, preferably at least 350 degree Celsius, more preferably at least 370 degree Celsius, most preferably at least 400 degree Celsius. These temperatures are typical operating temperatures for heating but not combusting the aerosol-forming substrate. Preferably, the operating temperature is in a range between 180 degree Celsius and 370 degree Celsius, in particular between 180 degree Celsius and 240 degree Celsius or between 280 degree Celsius and 370 degree Celsius. In general, the operating temperature may depend on at least one of the type of the aerosol-forming substrate to be heated, the configuration of the susceptor and the arrangement of the susceptor relative to the aerosol-forming substrate in use of the system. For example, in case the susceptor is configured and arranged such as to surround the aerosol-forming substrate in use of the system, the operating temperature may be in a range between 180 degree Celsius and 240 degree Celsius. Likewise, in case the susceptor is configured such as to be arranged within the aerosol-forming substrate in use of the system, the operating temperature may be in a range between 280 degree Celsius and 370 degree Celsius. The operating temperature as described above preferably refers to the temperature of the susceptor in use.

The controller may comprise a microprocessor, for example a programmable microprocessor, a microcontroller, or an application specific integrated chip (ASIC) or other electronic circuitry capable of providing control. The controller may comprise further electronic components, such as at least one DC/AC inverter and/or power amplifiers, for example a Class-C, a Class-D or a Class-E power amplifier. In particular, the inductive heating arrangement may be part of the controller.

The aerosol-generating device may comprise a power supply, in particular a DC power supply configured to provide a DC supply voltage and a DC supply current to the inductive heating arrangement. Preferably, the power supply is a battery such as a lithium iron phosphate battery. As an alternative, the power supply may be another form of charge storage device such as a capacitor. The power supply may require recharging, that is, the power supply may be rechargeable. The power supply may have a capacity that allows for the storage of enough energy for one or more user experiences. For example, the power supply may have sufficient capacity to allow for the continuous generation of aerosol for a period of around six minutes or for a period that is a multiple of six minutes. In another example, the power supply may have sufficient capacity to allow for a predetermined number of puffs or discrete activations of the inductive heating arrangement.

The aerosol-generating device may comprise a main body which preferably includes at least one of the inductive heating arrangement, in particular the at least one induction coil, the flux concentrator, the controller, the power supply and at least a portion of the cavity.

In addition to the main body, the aerosol-generating device may further comprise a mouthpiece, in particular in case the aerosol-generating article to be used with the device does not comprise a mouthpiece. The mouthpiece may be mounted to the main body of the device. The mouthpiece may be configured to close the receiving cavity upon mounting the mouthpiece to the main body. For attaching the mouthpiece to the main body, a proximal end portion of the main body may comprise a magnetic or mechanical mount, for example, a bayonet mount or a snap-fit mount, which engages with a corresponding counterpart at a distal end portion of the mouthpiece. In case the device does not comprise a mouthpiece, an aerosol-generating article to be used with the aerosol-generating device may comprise a mouthpiece, for example a filter plug.

The aerosol-generating device may comprise at least one air outlet, for example, an air outlet in the mouthpiece (if present).

Preferably, the aerosol-generating device comprises an air path extending from the at least one air inlet through the receiving cavity, and possibly further to an air outlet in the mouthpiece, if present. Preferably, the aerosol-generating device comprises at least one air inlet in fluid communication with the receiving cavity. Accordingly, the aerosol-generating system may comprise an air path extending from the at least one air inlet into the receiving cavity, and possibly further through the aerosol-forming substrate within the article and a mouthpiece into a user's mouth.

The at least one induction coil and the flux concentrator may be part of an induction module that is arranged within the device housing and which forms or is circumferentially arranged, in particular removably arranged around at least a portion of the cavity of the device.

As to this, the present invention also provides an induction module arrangeable within an aerosol-generating device such as to form or being circumferentially arranged around at least a portion of a cavity of the device, wherein the cavity is configured for removably receiving an aerosol-forming substrate to be inductively heated. The induction module comprises at least one induction coil for generating an alternating electromagnetic field within the cavity in use, wherein the at least one induction coil is arranged around at least a portion of the receiving cavity when the induction module is arranged in the device. The induction module further comprises a flux concentrator circumferentially arranged around at least a portion of the at least one induction coil and configured to distort the alternating electromagnetic field of the induction coil during use towards the cavity, when the induction module is arranged in the device. The flux concentrator comprises or is made of a flux concentrator foil according to the present invention and as described herein.

Further features and advantages of the induction module, in particular of the induction coil and the flux concentrator, have been described with regard to the aerosol-generating device and will not be repeated.

According to the invention there is also provided an aerosol-generating system which comprises an aerosol-generating device according to the invention and as described herein. The system further comprises an aerosol-generating article for use with the device, wherein the article comprises an aerosol-forming substrate to be inductively heated by the device. The aerosol-generating article is received or receivable at least partially in the cavity of the device.

As used herein, the term “aerosol-generating system” refers to the combination of an aerosol-generating article as further described herein with an aerosol-generating device according to the invention and as described herein. In the system, the article and the device cooperate to generate a respirable aerosol.

As used herein, the term “aerosol-generating article” refers to an article comprising at least one aerosol-forming substrate that, when heated, releases volatile compounds that can form an aerosol. Preferably, the aerosol-generating article is a heated aerosol-generating article. That is, an aerosol-generating article which comprises at least one aerosol-forming substrate that is intended to be heated rather than combusted in order to release volatile compounds that can form an aerosol. The aerosol-generating article may be a consumable, in particular a consumable to be discarded after a single use. For example, the article may be a cartridge including a liquid aerosol-forming substrate to be heated. Alternatively, the article may be a rod-shaped article, in particular a tobacco article, resembling conventional cigarettes.

As used herein, the term “aerosol-forming substrate” denotes a substrate formed from or comprising an aerosol-forming material that is capable of releasing volatile compounds upon heating for generating an aerosol. The aerosol-forming substrate is intended to be heated rather than combusted in order to release the aerosol-forming volatile compounds. The aerosol-forming substrate may be a solid or a liquid aerosol-forming substrate. In both cases, the aerosol-forming substrate may comprise both solid and liquid components. The aerosol-forming substrate may comprise a tobacco-containing material containing volatile tobacco flavor compounds, which are released from the substrate upon heating. Alternatively or additionally, the aerosol-forming substrate may comprise a non-tobacco material. The aerosol-forming substrate may further comprise an aerosol former. Examples of suitable aerosol formers are glycerine and propylene glycol. The aerosol-forming substrate may also comprise other additives and ingredients, such as nicotine or flavourants. The aerosol-forming substrate may also be a paste-like material, a sachet of porous material comprising aerosol-forming substrate, or, for example, loose tobacco mixed with a gelling agent or sticky agent, which could include a common aerosol former such as glycerine, and which is compressed or molded into a plug.

As mentioned before, the at least one susceptor element used for inductively heating the aerosol-forming substrate may be integral part of the aerosol-generating article, instead of being of part of the aerosol-generating device. Accordingly, the aerosol-generating article may comprises at least one susceptor element positioned in thermal proximity to or thermal contact with the aerosol-forming substrate such that in use the susceptor element is inductively heatable by the inductive heating arrangement when the article is received in the cavity of the device.

Further features and advantages of the aerosol-generating system according to the invention have been described with regard to the aerosol-generating device and will not be repeated.

The invention will be further described, by way of example only, with reference to the accompanying drawings, in which:

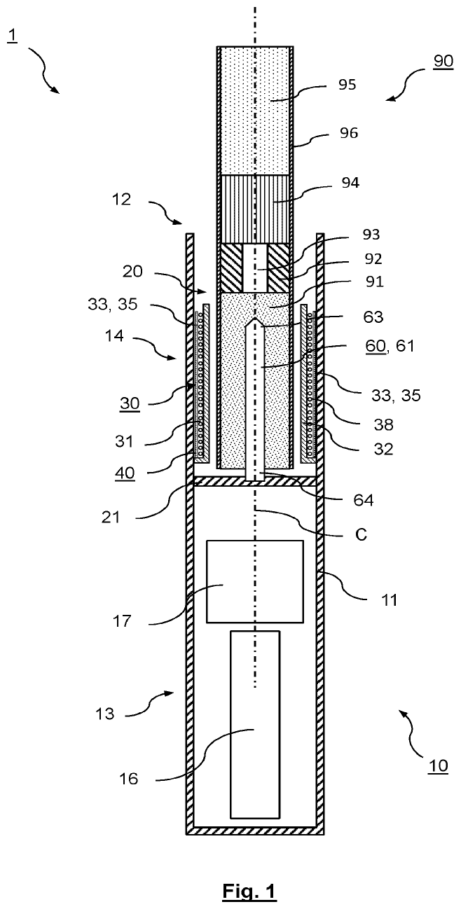

FIG. 1 shows a schematic longitudinal cross-section of an aerosol-generating system in accordance with a first embodiment the present invention;

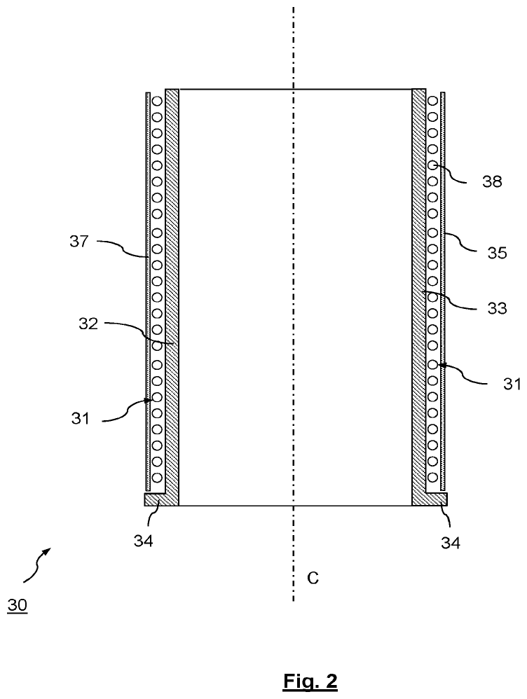

FIG. 2 is a detail view of the induction module according to FIG. 1;

FIG. 3 is a detail view of an induction module according to a second embodiment the present invention;

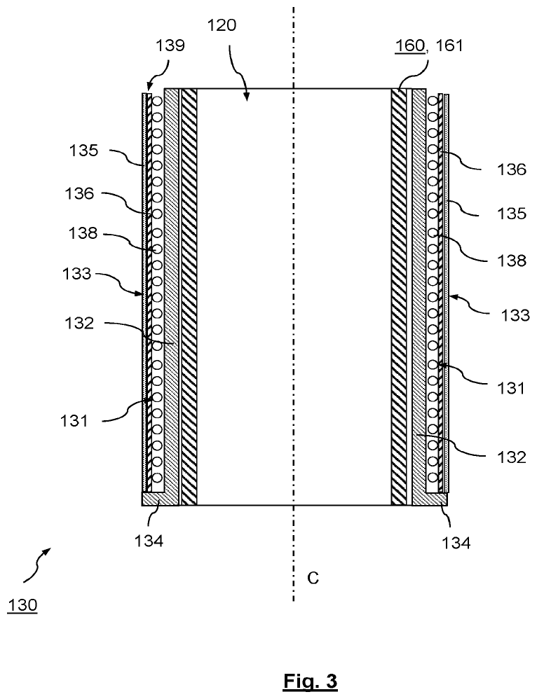

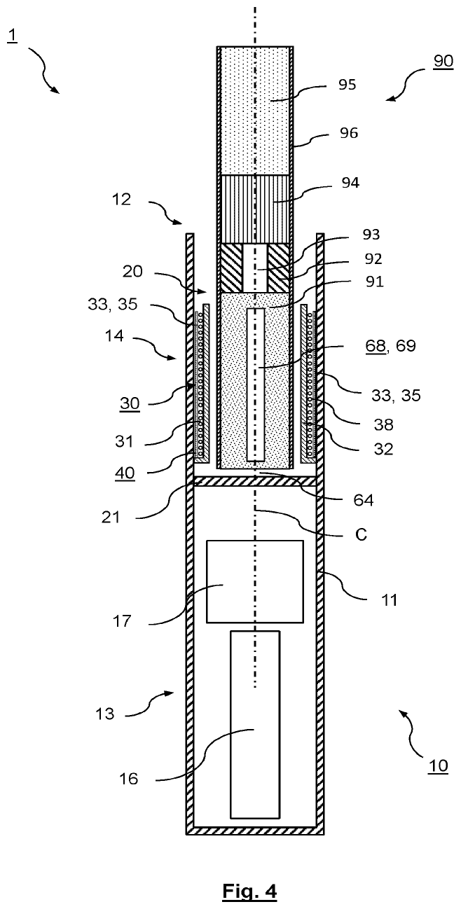

FIG. 4 shows a schematic longitudinal cross-section of an aerosol-generating system in accordance with a third embodiment the present invention;

FIGS. 5-8 show three different arrangements of a flux concentrator foil according to the present invention; and

FIG. 9 schematically illustrates an exemplary embodiment of a multi-layer flux concentrator foil according to the present invention.

FIG. 1 shows a schematic cross-sectional illustration of a first exemplary embodiment of an aerosol-generating system 1 according to the present invention. The system 1 is configured for generating an aerosol by inductively heating an aerosol-forming substrate 91. The system 1 comprises two main components: an aerosol-generating article 90 including the aerosol-forming substrate 91 to be heated, and an aerosol-generating device 10 for use with the article 90. The device 10 comprises a receiving cavity 20 for receiving the article 90, and an inductive heating arrangement for heating the substrate 91 within the article 90 when the article 90 is inserted into the cavity 20.

The article 90 has a rod shape resembling the shape of a conventional cigarette. In the present embodiment, the article 90 comprises four elements arranged in coaxial alignment: a substrate element 91, a support element 92, an aerosol-cooling element 94, and a filter plug 95. The substrate element is arranged at a distal end of the article 90 and comprises the aerosol-forming substrate to be heated. The aerosol-forming substrate 91 may include, for example, a crimped sheet of homogenized tobacco material including glycerin as an aerosol-former. The support element 92 comprises a hollow core forming a central air passage 93. The filter plug 95 serves as a mouthpiece and may include, for example, cellulose acetate fibers. All four elements are substantially cylindrical elements being arranged sequentially one after the other. The elements have substantially the same diameter and are circumscribed by an outer wrapper 96 made of cigarette paper such as to form a cylindrical rod. The outer wrapper 96 may be wrapped around the aforementioned elements so that free ends of the wrapper overlap each other. The wrapper may further comprise adhesive that adheres the overlapped free ends of the wrapper to each other.

The device 10 comprises a substantially rod-shaped main body 11 formed by a substantially cylindrical device housing. Within a distal portion 13, the device 10 comprises a power supply 16, for example a lithium ion battery, and an electric circuitry 17 including a controller for controlling operation of the device 10, in particular for controlling the heating process. Within a proximal portion 14 opposite to the distal portion 13, the device 10 comprises the receiving cavity 20. The cavity 20 is open at the proximal end 12 of device 10, thus allowing the article 90 to be readily inserted into the receiving cavity 20.

A bottom portion 21 of the receiving cavity separates the distal portion 13 of the device 10 from the proximal portion 14 of the device 10, in particular from the receiving cavity 20. Preferably, the bottom portion is made of a thermally insulating material, for example, PEEK (polyether ether ketone). Thus, electric components within the distal portion 13 may be kept separate from aerosol or residues produced by the aerosol generating process within the cavity 20.

The inductive heating arrangement of the device 10 comprises an induction source including an induction coil 31 for generating an alternating, in particular high-frequency electromagnetic field. In the present embodiment, the induction coil 31 is a helical coil circumferentially surrounding the cylindrical receiving cavity 20. The induction coil 31 is formed from a wire 38 and has a plurality of turns, or windings, extending along its length. The wire 38 may have any suitable cross-sectional shape, such as square, oval, or triangular. In this embodiment, the wire 38 has a circular cross-section. In other embodiments, the wire may have a flat cross-sectional shape.

The inductive heating arrangement further comprises a susceptor element 60 that is arranged within the receiving cavity 20 such as to experience the electromagnetic field generated by the induction coil 31. In the present embodiment, the susceptor element 60 is a susceptor blade 61. With its distal end 64, the susceptor blade is arranged at the bottom portion 21 of the receiving cavity 20 of the device. From there, the susceptor blade 61 extends into the inner void of the receiving cavity 20 towards the opening of the receiving cavity 20 at the proximal end 12 of the device 10. The other end of the susceptor blade 60, that is, the distal free end 63 is tapered such as to allow the susceptor blade to readily penetrate the aerosol-forming substrate 91 within the distal end portion of the article 90.

When the device 10 is actuated, a high-frequency alternating current is passed through the induction coil 31. This causes the coil 31 to generate an alternating electromagnetic field within cavity 20. As a consequence, the susceptor blade 61 heats up due to eddy currents and/or hysteresis losses, depending on the magnetic and electric properties of the materials of the susceptor element 60. The susceptor 60 in turn heats the aerosol-forming substrate 91 of the article 90 to a temperature sufficient to form an aerosol. The aerosol may be drawn downstream through the aerosol-generating article 90 for inhalation by the user. Preferably, the high-frequency electromagnetic field may be in the range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz).

In the present embodiment, the induction coil 31 is part of an induction module 30 that is arranged with the proximal portion 14 of the aerosol-generating device 10. The induction module 30 has a substantially cylindrical shape that is coaxially aligned with a longitudinal center axis C of the substantially rod-shaped device 10. As can be seen from FIG. 1, the induction module 30 forms a least a portion of the cavity 20 or at least a portion of an inner surface of the cavity 20.

FIG. 2 shows the induction module 30 in more detail. Besides the induction coil 31, the induction module 30 comprises a tubular inner support sleeve 32 which carries the helically wound, cylindrical induction coil 31. At one, the tubular inner support sleeve 32 has an annular protrusions 34 extending around the circumference of the inner support sleeve 32. The protrusions 34 are located at either end of the induction coil 31 to retain the coil 31 in position on the inner support sleeve 32. The inner support sleeve 32 may be made from any suitable material, such as a plastic. In particular, the inner support sleeve 32 may be a least a portion of the cavity 20, that is, at least a portion of an inner surface of the cavity 20.

Both the induction coil 31 and the inner support sleeve 32 (apart from the protrusion 34) are surrounded by a tubular flux concentrator 33 which extends along the length of the induction coil 31. The flux concentrator 33 is configured to distort the alternating electromagnetic field generated by the induction coil 31 during use of the device 10 towards the cavity 20. According to the invention, the flux concentrator 33 is made of a flux concentrator foil 35. The flux concentrator foil 35 comprises a material having a high relative magnetic permeability of at least 100, in particular of at least 1000, preferably of at least 10000, even more preferably of at least 50000, most preferably of at least 80000 at frequencies up to 50 kHz and a temperature of 25 degrees Celsius. Due to this, the electromagnetic field produced by the induction coil 31 is attracted to and guided by the flux concentrator 33. Thus, the flux concentrator 33 acts as a magnetic shield. This may reduce undesired heating of or interference with external objects. The electromagnetic field lines within the inner volume defined by the induction module 30 are also distorted by flux concentrator 33 so that the density of the electromagnetic field within the cavity 20 is increased. This may increase the current generated within the susceptor blade 61 located in the cavity 20. In this manner, the electromagnetic field can be concentrated towards the cavity 20 to allow for more efficient heating of the susceptor element 60.

In the present embodiment, the flux concentrator foil 35 has a thickness of about 0.1 mm (millimeters). It is a mono-layer foil made of mu-metal. The foil 35 is wound up in a single winding such as to form a tubular flux concentrator or a flux concentrator sleeve which comprises a single winding of the flux concentrator foil 35 surrounding the induction coil 31.

As can be further seen in FIG. 2, the flux concentrator foil 35 is directly wrapped around the induction coil 31 substantially without any radial spacing between the induction coil 31 and the flux concentrator foil 35.

FIG. 3 shows another embodiment of the induction module 130, in which the flux concentrator foil 135 is radially spaced apart from the induction coil 131. That is, the aerosol-generating device comprises a radial gap 139 between the induction coil 131 and the flux concentrator foil 135. In the present embodiment, the gap 139 is filled with a filler material 136, for example, a polyimide, such as poly(4,4′-oxydiphenylene-pyromellitimide), also known as Kapton®, or any other suitable dielectric materials. For example, the induction coil 131 may be wrapped by one or more layers of Kapton tape such as to fill the radial gap 139 between the induction coil 131 and the flux concentrator 133. The gap 139 or the filler material 136, respectively, may have a radial extension in a range between 40 micrometers and 240 micrometers, for example 80 micrometers. Advantageously, the gap 139 may help to reduce losses in the induction coil and to increase losses in the susceptor to be heated, that is, to increase the heating efficiency of the aerosol-generating device. Alternatively, the gap may be an air gap.

In contrast to the embodiment shown in FIG. 1 and FIG. 2, the susceptor element 160 according to the embodiment shown in FIG. 3 is a susceptor sleeve 161 which is arranged at the inner surface of the inner support sleeve 132 such as to surround the article when the article is received in the receiving cavity.

Apart from that, the embodiment shown in FIG. 3 is very similar to the embodiment shown in FIG. 1 and FIG. 2. Therefore, identical or similar features are denoted with the same reference signs, however, incremented by 100.

FIG. 4 shows a schematic cross-sectional illustration of an aerosol-generating system 1 according a third embodiment of the present invention. The system is identical to the system shown in FIG. 1, apart from the susceptor. Therefore, identical reference numbers are used for identical features. In contrast to the embodiment shown in FIG. 1, the susceptor 68 of the system according to FIG. 4 is not part of the aerosol-generating device 10 but part of the aerosol-generating article 90. In the present embodiment, the susceptor 68 comprises a susceptor strip 69 made of metal, for example, stainless steel, which is located within the aerosol-forming substrate of the substrate element 91. In particular, the susceptor 68 is arranged within the article 90 such that upon insertion of the article 90 into the cavity 20 of the device 10, the susceptor strip 69 is arranged the cavity 20, in particular within the induction coil 31 such that in use the susceptor strip 69 experience the magnetic field of the induction coil 31.

In principle, the flux concentrator foils 35, 135 may be wound up in different ways around the induction coil 33, 133. According to a first embodiment, the flux concentrator foil 35 may be wound up with its free ends 37, 137 abutting against each other as shown in FIG. 5. That is, the longitudinal edges of the flux concentrator foils which extend along the length axis of C of the aerosol-generating device abut against each other.

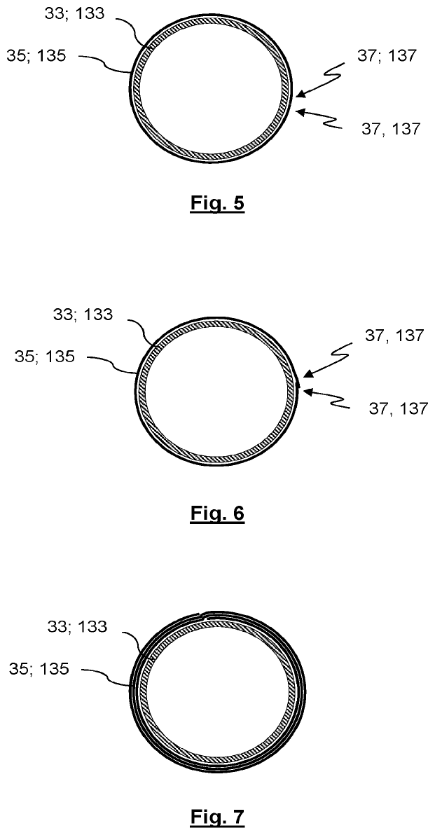

According to a second embodiment, the flux concentrator foil 35, 135 may be wound up with free ends 37, 137 overlapping each other as shown in FIG. 6. That is, the longitudinal edges of the flux concentrator foils 35, 135 which extend along the length axis of C of the aerosol-generating device abut against each other.

In case the flux concentrator foil is wound up, in particular in a single winding, such as to form a tubular flux concentrator or a flux concentrator sleeve, the concentrator foil may be attached to an inner surface of the device housing in a force-fitting manner due a partial release of an elastic restoring force of the wound-up flux concentrator foil. That, the elastic restoring force presses the concentrator foil radially outwards against the inner surface of the device housing. With reference to FIGS. 1, 2, and 4, such a flux concentrator foil may be easily inserted through the opening of the cavity 20 at the proximal end of the aerosol-generating device 10 into the radial slit between the outer surface of the support sleeve 32 and the inner surface of the device housing.

According to a third embodiment as shown in FIG. 7, the flux concentrator foil 35, 135 may be wound up in multiple windings such as to form a tubular flux concentrator or a flux concentrator sleeve comprising multiple, in particular spiral windings of a flux concentrator foil overlapping each other.

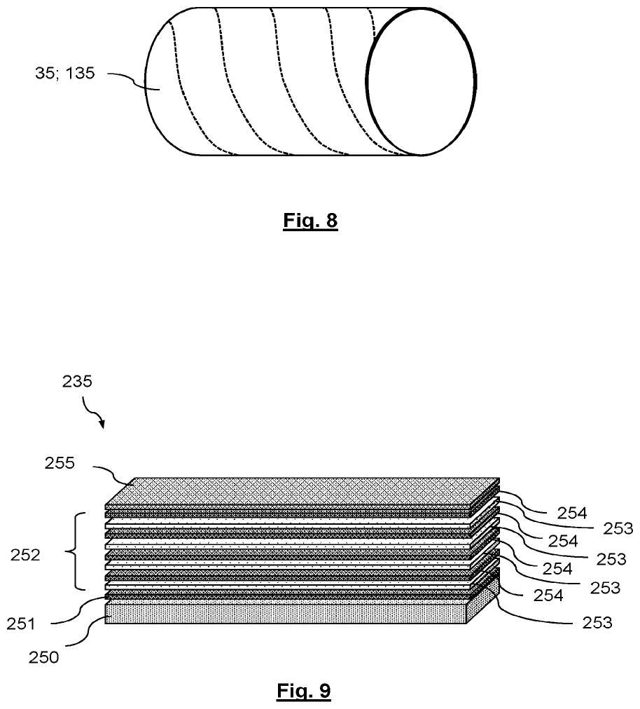

According to a fourth embodiment as shown in FIG. 8, the flux concentrator foil 35, 13 may also be wound up helically in an axially direction with respect to winding axis, that is, along the length axis of C of the aerosol-generating device, such as to form a tubular flux concentrator or a flux concentrator sleeve comprising one or more helical windings of a flux concentrator foil 35, 135.

The two latter configurations shown in FIG. 7 and FIG. 8 may be advantageously used to generate a multi-layer flux concentrator (foil), wherein each winding corresponds to one layer.

Instead of using multiple windings of a flux concentrator foil for generating a multi-layer flux concentrator, the flux concentrator foil itself may be a multi-layer flux concentrator foil. FIG. 9 shows an exemplary embodiment of such a multi-layer flux concentrator foil 235 in a cross-sectional view. In this embodiment, the multi-layer flux concentrator foil 235 comprises a substrate layer film 250, such as an adhesive tape and a layer of a ferromagnetic material disposed upon the substrate layer. On top of the substrate layer film 250, the multi-layer flux concentrator foil 235 comprises a layer of a first ferromagnetic material 251. On top of the layer of the first ferromagnetic material 251, the multi-layer flux concentrator foil 235 comprises a multilayer stack 252 comprising a plurality of pairs of layers, each pair comprising a spacing layer 253 and a layer of a second ferromagnetic material 254 disposed upon the spacing layer 253. The layers of the first and second ferromagnetic material 251, 254 may comprise or may be made of a foil. Preferably, each foil comprises or is made of at least one of a permalloy, a Nanoperm® alloy, a Vitroperm® alloy, such as Vitroperm 800, or a Metglas® brazing foil. In principle, the first and the second ferromagnetic material may be the same or may be different from each other The spacing layers 253 may be dielectric layer or a non-electrically conductive material to suppress the eddy current effect. For example, the spacing layers 253 may be comprise or may be made of an acrylic polymer or a ferromagnetic material with relatively lower magnetic permeability.

In addition, the multi-layer flux concentrator foil 235 comprises a protective layer 255 on top of the multilayer stack 252. The protective layer may comprise or may be made of polymers or ceramics.

Both, the substrate layer film 250 and the protective layer 255, form the outermost or edge layers of the multi-layer flux concentrator foil 235.

The layers of ferromagnetic material 253 may each have a thickness of about 16 micrometers to 20 micrometers, for example 18 micrometers.

The total thickness of the multi-layer flux concentrator foil 235 may be in range between 0.1 millimeters and 0.2 millimeters, for example 0.15 millimeters.

1.-15. (canceled)

16. An aerosol-generating device for generating an aerosol by inductive heating of an aerosol-forming substrate, the aerosol-generating device comprising:
a device housing comprising a cavity configured to removably receive the aerosol-forming substrate to be heated;
an inductive heating arrangement comprising at least one induction coil configured to generate an alternating magnetic field within the cavity, wherein the at least one induction coil is arranged around at least a portion of the cavity; and
a flux concentrator arranged around at least a portion of the induction coil and configured to distort the alternating magnetic field of the at least one inductive heating arrangement towards the cavity, wherein the flux concentrator comprises or is made of a flux concentrator foil, and wherein the flux concentrator foil comprises at least one of a permalloy or a nano-crystalline soft magnetic alloy.

17. The aerosol-generating device according to claim 16, wherein the flux concentrator foil has a thickness in a range between 0.02 mm and 0.25 mm.

18. The aerosol-generating device according to claim 16, wherein the flux concentrator foil has a thickness in a range between 0.1 mm and 0.15 mm.

19. The aerosol-generating device according to claim 16, wherein the flux concentrator foil is wound up, with ends overlapping each other or abutting against each other, so as to form a tubular flux concentrator or a flux concentrator sleeve.

20. The aerosol-generating device according to claim 19, wherein the flux concentrator foil is attached to an inner surface of the device housing in a force-fitting manner due a partial release of an elastic restoring force of the wound-up flux concentrator foil.

21. The aerosol-generating device according to claim 19, wherein the ends overlapping each other or abutting each other are attached to each other.

22. The aerosol-generating device according to claim 16, wherein the flux concentrator foil is a single-layer foil or a multi-layer foil.

23. The aerosol-generating device according to claim 16, wherein the flux concentrator foil further comprises or is made of a material or materials having a relative maximum magnetic permeability of at least 1,000 for frequencies up to 50 kHz and a temperature of 25 degrees Celsius.

24. The aerosol-generating device according to claim 16, wherein the flux concentrator foil further comprises, in particular is made of a material or materials having a relative maximum magnetic permeability of at least 10,000 for frequencies up to 50 kHz and a temperature of 25 degrees Celsius.

25. The aerosol-generating device according to claim 16, wherein the flux concentrator foil further comprises or is made of at least one ferromagnetic or ferrimagnetic material.

26. The aerosol-generating device according to claim 16,
wherein the inductive heating arrangement comprises a plurality of induction coils, and
wherein the flux concentrator is arranged around at least a portion of one of the induction coils of the plurality of induction coils.

27. The aerosol-generating device according to claim 16,
wherein the inductive heating arrangement comprises a plurality of induction coils, and
wherein the flux concentrator is arranged around at least a portion of each one of the induction coils of the plurality of induction coils.

28. The aerosol-generating device according to claim 16, further comprising a radial gap between the at least one induction coil and the flux concentrator having a radial extension in a range between 40 micrometers and 400 micrometers.

29. The aerosol-generating device according to claim 16, further comprising a radial gap between the at least one induction coil and the flux concentrator having a radial extension in a range between 100 micrometers and 240 micrometers.

30. The aerosol-generating device according to claim 16, further comprising at least one susceptor element arranged at least partially within the cavity.

31. The aerosol-generating device according to claim 30, wherein the at least one susceptor element is a tubular susceptor or a susceptor sleeve.

32. An aerosol-generating system, comprising:
an aerosol-generating device according claim 16; and
an aerosol-generating article received or receivable at least partially in a cavity of the aerosol-generating device, wherein the aerosol-generating article comprises an aerosol-forming substrate to be heated.

33. The aerosol-generating system according to claim 32, wherein the aerosol-generating article further comprises at least one susceptor positioned in thermal proximity to or thermal contact with the aerosol-forming substrate such that the at least one susceptor is inductively heatable by the inductive heating arrangement of the aerosol-generating device when the aerosol-generating article is received in the cavity of the aerosol-generating device.
